(19) United States
(12) Patent Application Publication
(10) Pub. No.: US 2011/0099053 A1
(43) Pub. Date: Apr. 28, 2011

(54) METHOD AND SYSTEM FOR MONITORING SUCCESSFUL USE OF APPLICATION SOFTWARE

(76) Inventors: Robert T. IRIZARRY, JR., Bozeman, MT (US); Steven D. Daines, Bozeman, MT (US)

(21) Appl. No.: 12/951,682

(22) Filed: Nov. 22, 2010

Related U.S. Application Data
(63) Continuation-in-part of application No. 10/837,306, filed on Apr. 30, 2004, now abandoned.

(51) Int. Cl. G06Q 10/00

(52) U.S. Cl. 705/7.38

(57) ABSTRACT

A method and system for monitoring the success level with which application software is being used by customers so that its successful use can be encouraged. Factors that are common to customers known to be using the software are identified and used in an algorithmic process to generate a success level score for each customer or for each plurality of customers as a measure of how successfully the customer or the combined plurality of customers is using the software. Factors that are inapplicable to a particular customer are excepted from the algorithmic process for that customer. Any factor that is being used collectively by the customers at a high level of success is removed and replaced by a new factor to assure continuing accuracy of the success level score. The scores and other data can be displayed in a number of ways useful both to the customers and the software supplier.

### CROSS-REFERENCE TO RELATED APPLICATIONS

This application is a continuation-in-part of and claims priority to U.S. application Ser. No. 10/837,306, filed Apr. 30, 2004 and entitled METHOD AND SYSTEM FOR MONITORING SUCCESSFUL USE OF APPLICATION SOFTWARE, which is hereby incorporated by reference herein to the extent permitted by law.

### STATEMENT REGARDING FEDERALLY SPONSORED RESEARCH OR DEVELOPMENT

Not applicable.

### TECHNICAL FIELD

The present invention relates to a method and system that allows a software supplier to determine how effectively and successfully its customers are using the software.

### BACKGROUND OF THE INVENTION

Software of various types is commonly supplied on a subscription basis where customers decide to renew or not to renew at the end of each subscription term. It is to the benefit of the supplier that its customers use the software successfully because the customers are then more likely to renew the subscription and generate additional revenue to the supplier. However, prevalent practice has been for the suppliers to simply license the software and check near the end of the subscription term to seek renewal, without the suppliers knowing how successfully its customers are using the software or having any ability to affect how it is being used. For example, if software has a variety of features that are available, a customer may not use one of the features which, if used, could significantly enhance the value the customer could obtain from the product. Accordingly, at the end of the subscription term, such a customer may decide not to extend the subscription without ever knowing that the software could greatly benefit his business operations if it were to make use of all of the features the software offers.

It is evident that both the customers and the suppliers could benefit if the suppliers maintain awareness of how the customers are using their products and have the ability to suggest ways to use them more effectively, especially in situations where customers are not taking full advantage of all of the functions and features that are available. If the customers are made aware of ways in which they can use the software more effectively, their business operations would be more successful. This would also benefit the supplier because the customers would be pleased with the software due to their successful use of it and more likely to renew their subscriptions. However, past practice has largely been for the suppliers to have little or no interaction with their customers and little or no awareness of the way their software is being used at the customer level.

### SUMMARY OF THE INVENTION

The present invention generally relates to a method and system that allows a software supplier to monitor the level of success with which its software is being used. The principal advantage is that the supplier can attempt to redress deficiencies in the software use in order to improve the way in which its products are used. In turn, the customer can make more effective use of the software and can obtain more value from it. The supplier benefits because the more successful use by the customer makes the customer more likely to renew its subscription.

It is an important object of the invention to provide a method and system for determining how successfully software customers are using their application software.

Another important object of the invention is to provide a method and system of the character described in which both the supplier and the customer have available to them data indicating the success level with which the software is being used. If the customer is not using the product successfully, it is informed of that fact and is also informed of what it can do to improve its usage. Because the supplier also knows of the deficiency in use, the supplier can contact and work with the customer to attempt to improve the way the software is used, to the benefit of both the supplier and the customer. This improves how the software application is used but does not change the actual software application itself.

A further object of the invention is to provide a method and system of the character described that makes use of a unique algorithmic process to accurately determine the level of success with which the software is being use. It is an important feature of the invention in this respect that the algorithm is based on factors that are known to be common to successful users, so applying those factors to each user provides an accurate measure of the success level for each user.

An additional object of the invention is to provide a method and system of the character described wherein the algorithmic process is adjusted as conditions change due to business considerations or general across the board improvement in one aspect of use that makes one of the success factors no longer an accurate indication of successful usage. In this regard, the system is arranged so that it can be adjusted and updated to current conditions by replacing one of the success factors with a new one if a time comes that one of the factors has essentially served its purpose and is no longer a valid measure of successful use. Additionally, the system can be custom tailored to fit each customer such that if one of the success factors is inapplicable to a particular customer, that factor is removed from the algorithmic process for that customer in order to avoid an inaccurate or invalid score.

Yet another object of the invention is to provide a method and system of the character described in which an alert indication is provided if there is an unduly low success level for any customer or a relatively sudden deviation in the level of success for any customer.

A still further object of the invention is to provide a method and system of the character described wherein the success ratings for the customers are available to be displayed in a variety of ways such as in a display containing all customers of the supplier, a display identifying account managers of the supplier and the customers assigned to each account manager, or a display containing only selected customers, with each display including the success level of the customer and a rating of each customer as to each of these success factors. The variety of different displays that are available provides great flexibility so that information obtained by the system can be made available to a number of different people in a number of different formats that can be selected to provide the proper people with the information they need to make effective use of the system.

Other and further objects of the invention, together with the features of novelty appurtenant thereto, will appear in the course of the following description.

### BRIEF DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views:

FIG. 1 is a flow diagram of an algorithmic process that may be used to carry out the method and system in accordance with a preferred embodiment of the present invention;

FIG. 2 is an architectural block diagram of a method and system implemented in accordance with a preferred embodiment of the invention;

FIG. 3 is a chart identifying a number of success factors and the way in which they may be used in accordance with the algorithmic process carried out in accordance with a preferred embodiment of the invention;

FIG. 4 is an exemplary display of the success level for a hypothetical software customer resulting from application of the algorithmic process to that customer in accordance with a preferred embodiment of the invention;

FIG. 5 is an exemplary display showing sales personnel of a hypothetical software supplier and the value of their accounts and the scoring of their assigned customers that may be generated in accordance with a preferred embodiment of the invention;

FIG. 6 is an exemplary display that ranks the sales personnel of a hypothetical software supplier that may be generated in accordance with a preferred embodiment of the present invention;

FIG. 7 is an exemplary display of a hypothetical sales person and the customers assigned to that sales person which may be generated in accordance with a preferred embodiment of the present invention;

FIG. 8 is an exemplary display that includes selected customers assigned to a particular sales person generated in accordance with a preferred embodiment in the present invention; and

FIG. 9 is an exemplary chart in graph form showing the scoring for the customers assigned to a number of selected hypothetical sales people that may be generated in accordance with a preferred embodiment of the present invention.

### DESCRIPTION OF THE PREFERRED EMBODIMENT OF THE INVENTION

The present invention is directed to a method and system that functions, in a preferred embodiment, to monitor the success level at which software is being used by a customer of a software supplier that licenses application software on a renewable subscription basis. For explanatory purposes, the preferred embodiment of the invention will be directed to a company that licenses application software used by its customers in connection with websites that allows visitors to the website to ask questions and to send e-mails seeking information or including questions about the products or services that are offered by the company sponsoring the website. For example, the company that maintains the website may be a retailer, and its website may be either maintained by the company itself or hosted by the supplier of the software. In either case, again for explanatory purposes, the website may have a knowledge engine that contains answers to commonly asked questions, and optionally, the capability of receiving e-mails seeking information that is outside of the scope of anything contained in the knowledge engine, thus requiring intervention by a human operator to answer questions that go beyond what is available in the information base contained in the knowledge engine.

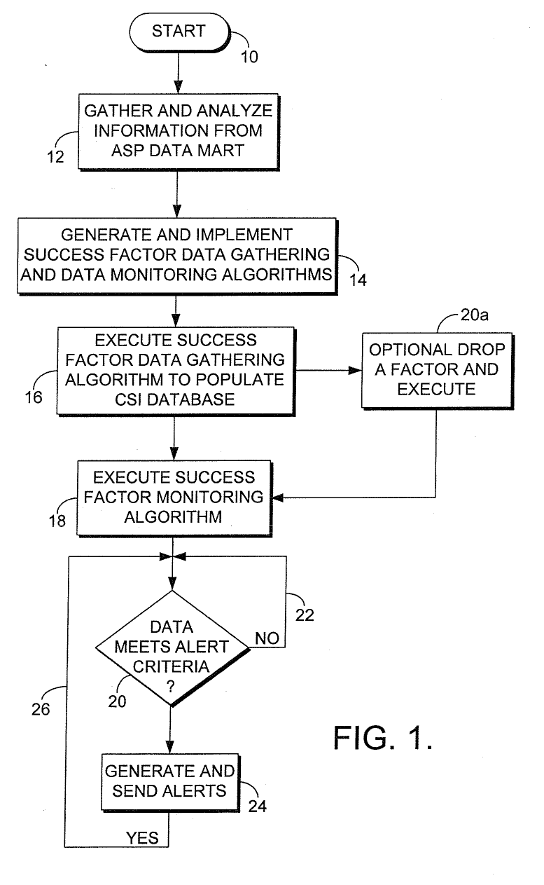

Referring initially to FIG. 1, an algorithmic process that is used to provide a “score” that is indicative of the success level with which the software customers are making use of the software is shown in flow diagram form. The algorithmic process includes a start function implemented in block 10. In block 12, information from the application service provider (ASP) data base is gathered and analyzed. For example, if the supplier of the application software hosts the websites of a number of its customers, the software supplier is provided with information as to how the software it supplied is being used by each customer and how successful the customers are in using the software. That information can be maintained in the data base and gathered and analyzed for each such customer in block 12. In block 14, success factor data gathering and data monitoring algorithms are generated and implemented. The success factor data gathering involves determining features and functions used by customers that are known to be successfully using the software. The extent to which these features and functions (success factors) are used thus provides an accurate measure of how successfully any customer is making use of the software. As will be explained more fully, certain functions and features of software can be used to generate a scoring system that, when applied to all of the software customers, indicates how successfully they are using the software. By way of background information and not to be limiting to the present invention, known and common features associated with ASPs and ASP hosted software are that (1) ASP fully owns and operates the software application(s), (2) ASP owns, operates and maintains the serves that support the software application, (3) ASP makes information available to customers via the Internet, and (4) ASP bills on a “per-use” basis or on a monthly or annual subscription-type fee.

In block 16, the success factor data gathering algorithm is executed in order to populate the database of the method and system in the present invention. In block 18, the success factor monitoring algorithm is executed. Block 20a is an optional block that can be entered between blocks 16 and 18 for particular customers. As will be explained more fully, some customers may operate their businesses in a manner where one or more of the success factors that are generally applicable do not provide an accurate indication of success. Accordingly, the factors that are not indicative of success for particular customers are removed before the algorithmic process is executed in block 18. From block 18, block 20 is entered and a determination is made as to whether the data for a particular customer indicate that an alert should be generated for that customer. If the alert criteria are not met by the data, the program simply loops back as indicated at 22. If the alert criteria are met, block 24 is entered and an alert is generated and sent. The program then loops back as indicated at 26.

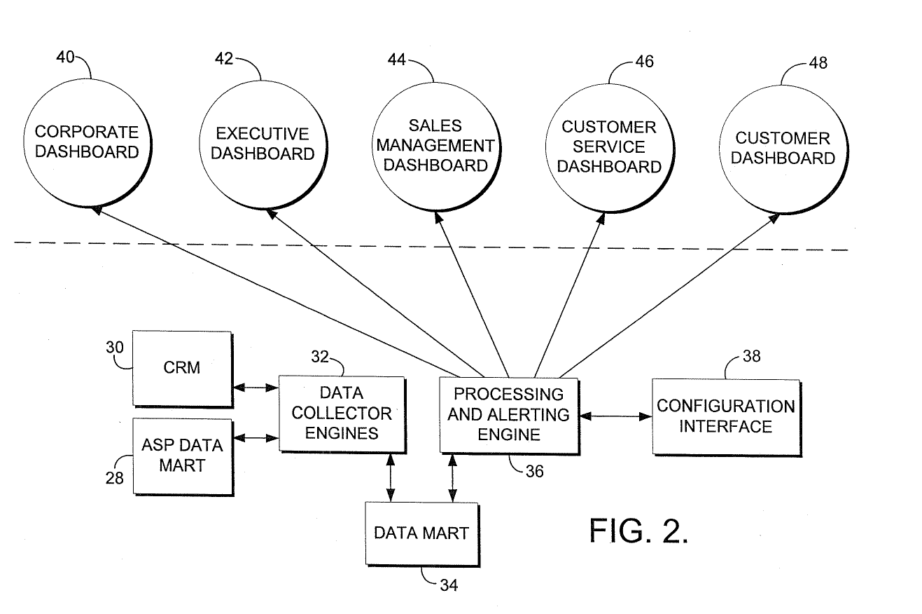

With reference to FIG. 2, data that is used by the method and system in the present invention can be obtained from an application service provider database 28 and/or from another database 30 containing relevant information. These data are provided to data collection engines 32 that interact with a data mart indicated at block 34. The data from the data mart may be provided to the processing and alerting engine 36 that operates in accordance with the method and system in the present invention. A configuration interface 38 is provided.

The processing and alerting engine 36 implemented in accordance with the present invention may be used to provide a variety of different displays which are available to different people and in different formats. For example, block 40 represents a corporate “dashboard” which is a display that may be made available on computer terminals (or other monitors) to the entire organization of the software supplier. Another display 42 may be available only to selected executives of the software supplier. A further display 44 may be made available only to personnel of the software supplier who are involved in sales management. Another display 46 may be made available to those personnel associated with the software supplier who provide customer service. Finally, each customer of the software supplier may be provided with its own display 48 that contains information applicable to that particular customer. It is possible therefore for different personnel in the company as well as the customer to supply information to the application software to increase the success of that application software for the individual customer and in generally for customers.

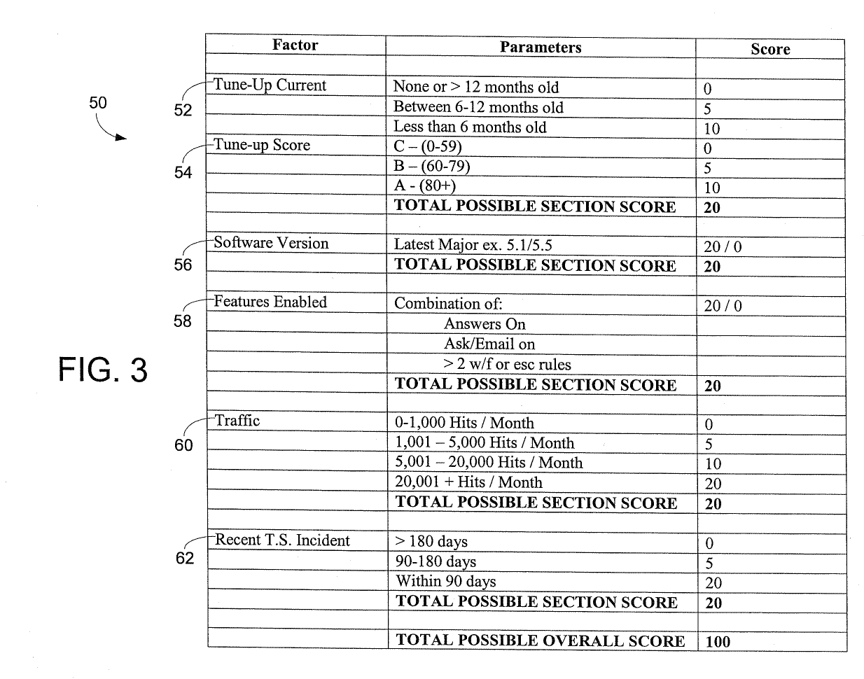

FIG. 3 is a chart that identifies success factors and a manner in which they may be used to provide a scoring system that indicates the level of success with which customers are using the application software. The factors that are listed in FIG. 3 have been determined to be indicative of successful software use thereby tracking if the customers are gaining value from the application software. For example, users of the software who are known to be using it successfully can be analyzed with respect to their use to determine which functions and features of the software are being used by all of the successful users. These factors thus provide an accurate measure of how successfully the software is being used by all customers.

One factor identified in FIG. 3 is a “tune up” factor which is generally identified by numeral 50 in FIG. 3 and which is composed of two different factors, the recency of the “tune up” 52 and the score of the “tune up” 54. The second success factor identified in FIG. 3 is the software version 56 that the customer is currently using. The third success factor is a “features enabled” factor 58. The amount of traffic 60 is a fourth factor. Finally, the recency of technical support incidents is identified on FIG. 3 as the last factor 62.

The “tune up” factor 50 may be a technique used by the software supplier to periodically check with the customer at various times during the life cycle of the product in order to determine how the customer is doing with the software (much like a periodic tune up of an automobile). Some of the information used by a tune up consultant associated with the software supplier may be determined programmatically if the customer is using a system that is hosted by the software supplier. Other information required for the tune up may be obtained from the customer.

In any case, a scoring system for the tune up factor 50 may include ten points attributable to the recency of the tune up and another ten points attributable to the score of the tune up. For example, if there has been a tune up as current as six months ago, a score of ten points may by assigned to the customer. If a tune up has occurred in the time period of six to twelve months ago, a score of five points may be assigned to the customer. A tune up greater than twelve months ago or if none has ever been performed yields a score of zero for the customer. Similarly, if the tune up score for the last tune up is eighty or above, a grade of A may be assigned to the customer and a score of ten points may be attributed to the tune up score. A tune up score between sixty and seventy-nine may be assigned a rating of B and a score of five points. A tune up score between zero and fifty-nine may be given a grade of C and assigned a score of zero. As indicated in FIG. 3, a total of twenty points may be assigned to a customer based on the tune up, with ten of those points being available from the recency aspect of the tune up and the other ten available from the score aspect of the tune up.

It has been determined that having the most recent software version is an important aspect of the success level with which customers use the software. Accordingly, a customer having the latest major software version is assigned a score of twenty, while all other customers are assigned a score of zero. Thus, twenty total points are available based on the software version factor 56, with the score being an all or nothing situation depending upon whether or not the customer has the latest major software version that is available.

The next factor is the features enabled factor 58. It has been determined that certain features must be used in order for customers to generally operate the software in a successful manner. For example, there may be a self service feature of the software which allows customers to find their own answers on the website of the software customer, but this can only be done if the “answers on” function is enabled. Likewise, in a situation where an answer is not available in the knowledge engine database, the customer must have the “ask/e-mail on” feature enabled so that customers can send in an e-mail and obtain a valid answer, either from a database or from a human operator. Additionally, the software functions most effectively if the business portion of the application software is used in a manner involving work flow or escalation rules, of which the software customer should use more than two. Thus, if all three of these functions are enabled, a particular customer would achieve a score of twenty for the features enabled factor 58. Again, this is an all or nothing proposition in that all three of these functions or features must be in use in order for the customer to obtain a score of twenty, whereas less than all of these features being enabled results in a score of zero.

The fourth success factor is a traffic factor 60. If the website of the software customer achieves traffic of zero to one thousand hits per month, a score of zero is assigned. Higher traffic levels achieve higher scores, with a total possible score attributable to the traffic factor 60 being twenty, as indicated in FIG. 3.

The final success factor relates to how recently the software customer has had a technical service incident which most commonly is a request for technical service. By way of example, if there has been no technical service incident within one hundred and eighty days, a score of zero can be assigned. An incident in the time frame of ninety to one hundred eighty days may result in a score of five for this factor. Finally, if a technical service incident has occurred within ninety days, the customer may achieve a score of twenty. Again, the total possible score available for factor 62 is twenty points.

Thus, each of the five factors has a total possible score of twenty such that one hundred points is the maximum number of points available for the overall score.

One or more of the success factors may be inapplicable to a particular customer. For example, a particular customer might simply operate a call center and not allow customers to use the “self service” aspect of the application software due to the business model under which the customer operates. In this case, the features enabled factor 58 is inapplicable to the customer. Accordingly, factor 58 is removed from the algorithmic process used to determine the score of that customer. The customer is given a score based on the other four factors which are re-weighted to take into account the deletion of the features enabled factor 58. In this way, a factor that is inapplicable to a particular customer is removed so that the score obtained for that customer is not made inaccurate or invalid due to the inapplicable factor. It is noted that other factors may be inapplicable to certain customers for other reasons, including the business model under which the customer choose to operates. The size of the customer may invalidate the traffic factor 60, at least insofar as the “hits per month” numbers are applicable. The remaining factors may be inapplicable to certain customers for other reasons.

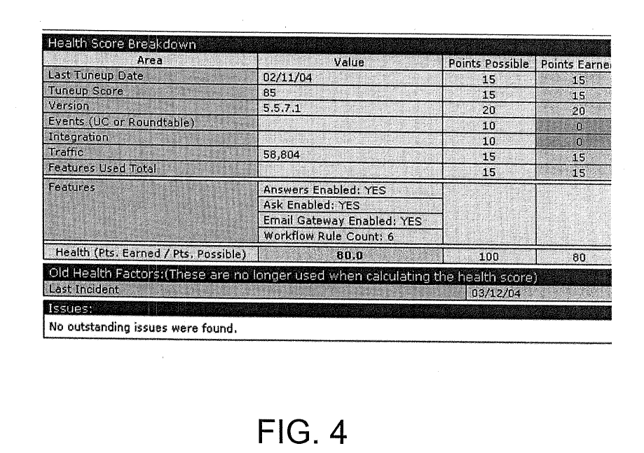

In accordance with the invention, data are gathered from each customer that is using the software of the software supplier, and the five success factors (or less in some cases) are applied to each customer using the algorithmic process to provide a “score” for each customer according to the way in which the factors are considered in the chart of FIG. 3. The result is that each customer has a “health score” having a maximum one hundred points. The health score provides an accurate measure of the level of success with which each customer is making use of the software. FIG. 4 is a display that may be made available by the system of the present invention relative to a hypothetical customer. A display which is similar to that of FIG. 4 is available as to each customer, setting forth the customer identification, the success factors and the scores attained by the customer for each success factor, and the total score for the customer.

In the example shown in FIG. 4, the customer deficiencies are in the recency of the tune up and the software version that is being used. The customer achieved an overall score of 80 points out of a possible one hundred due to the deficiencies in these two success factors. As indicated at the bottom of the chart shown in FIG. 4, there may be a note to the effect that a tune up should be scheduled and another note to the effect that the software version that is being used by the customer is not the newest release. The customer charts such as that of FIG. 4 are made available to various personnel within the organization of the software supplier and can also be made available to the customer so that the customer is informed of the deficiencies and how to correct them. At the same time, sales personnel of the software supplier are made aware of the deficiencies as to this customer and can contact the customer to inform it of the deficiencies and how they can be corrected.

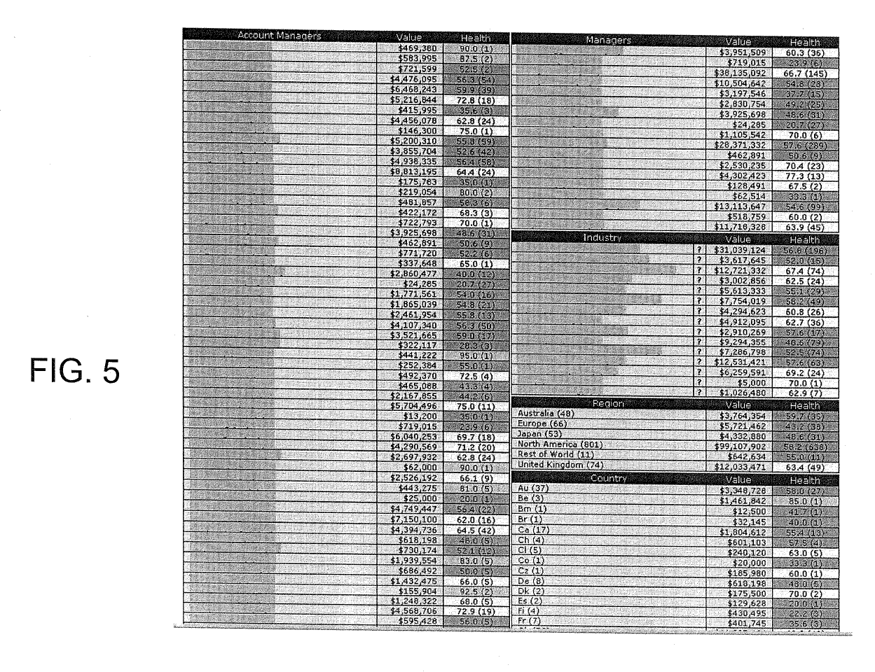

FIG. 5 is an example of a chart that may be available to the software supplier and may identify each of the account managers (under the “account managers” heading), the sales managers (under the “managers” heading), the value of the software supplied to the customers assigned to each manager, and the average “health score” for the customers assigned to each manager. Additionally, the chart of FIG. 5 can include different industry segments that are using the supplier's software, such as consumer products companies, technology companies and the like, along with the overall value of the software being used by each industry group and the overall average health score of the companies that are within each industry group. Information regarding various geographic regions and countries can also be provided in a similar fashion in the chart of FIG. 5.

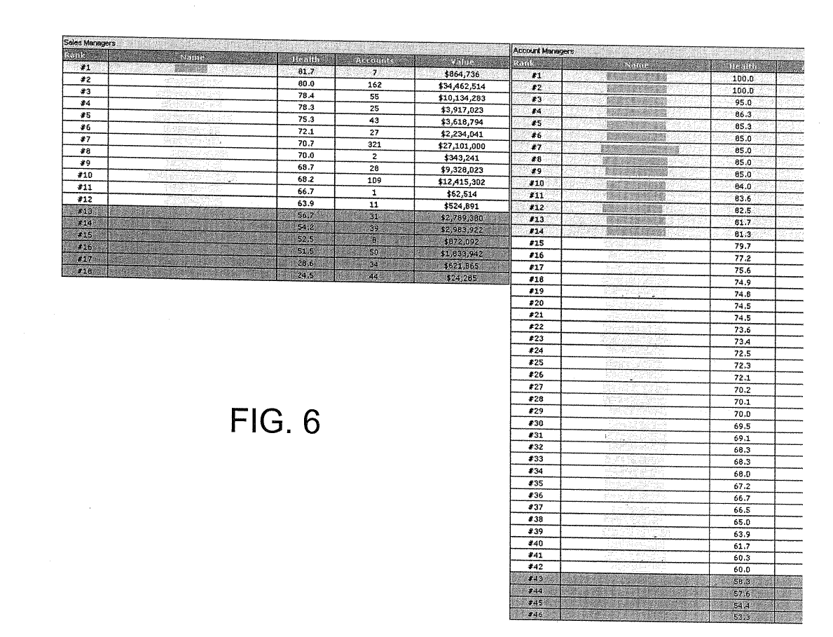

FIG. 6 depicts a representative chart that ranks each of the sales managers and account managers of the software supplier according to the average health achieved by the accounts assigned to each manager. Charts such as that of FIG. 6 are supplied to the sales personnel of the software supplier on a periodic basis such as monthly. The value of the chart of FIG. 6 is that it provides the sales organization with information as to how the various sales managers and account mangers rate with respect to the health scores achieved by their customers relative to others in the sales organization.

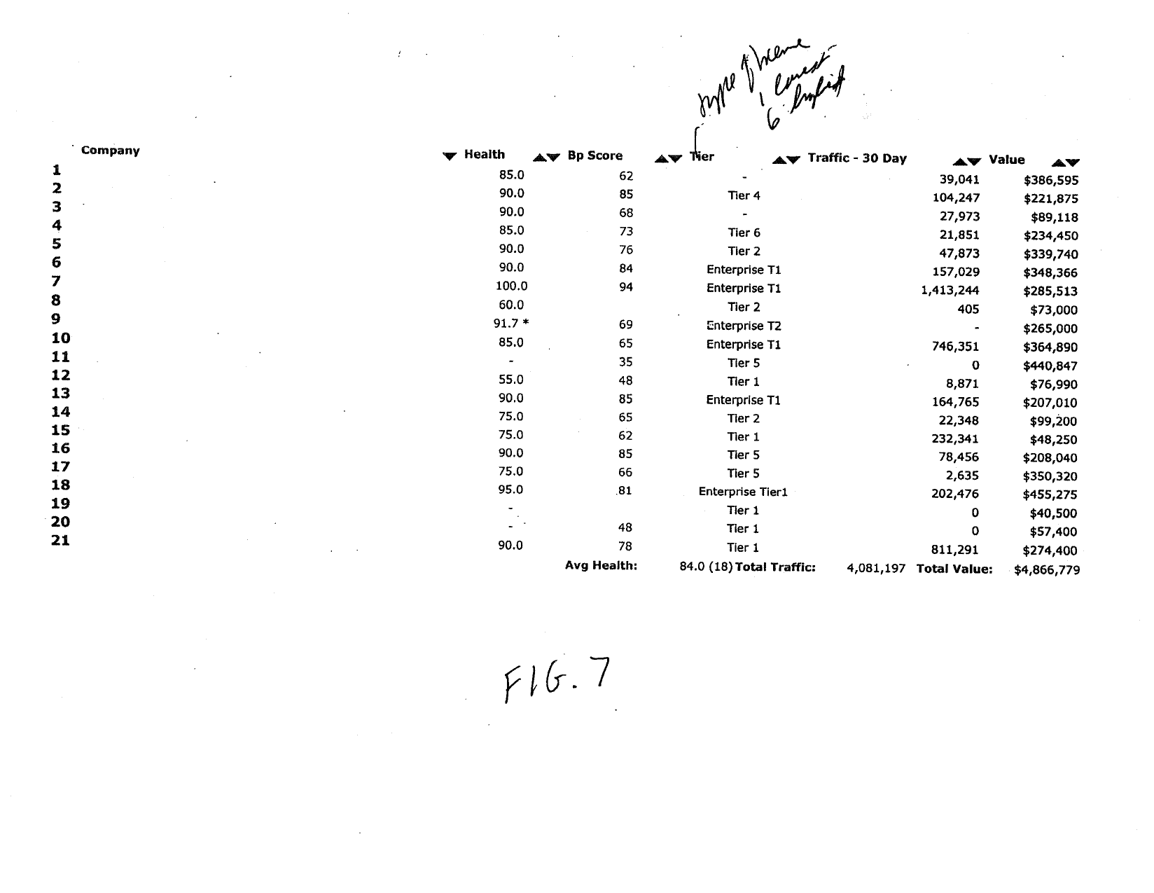

FIG. 7 depicts another chart that is available to be displayed on computer screens or otherwise to those in the sales organization of the software supplier. The chart of FIG. 7 is a hypothetical chart for a particular sales person identifying each customer that has been assigned to the sales or account manager, the “health score” for each such customer and various other information, including a “bp score” (a best practices score which may represent a measure of the value the customer is receiving from the software it is using), a “tier” factor which may be the level of license the customer has purchased, a traffic measure for the last thirty day period, and the value of the software the customer is using. A display of the type shown in FIG. 7 is available to each account manager and sales manager within the organization of the software supplier so that each such person can monitor the success level with which each of his or her customers is making use of the software.

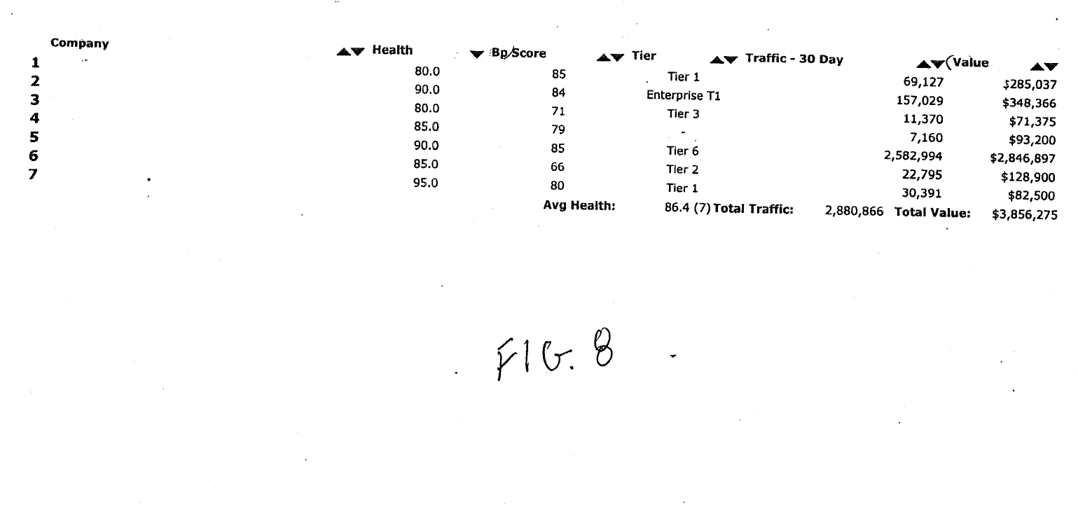

FIG. 8 depicts another chart which may be made available on computer monitors or otherwise to persons within the software supplier. It contains only selected customers of a particular sales manager or account manager, usually selected because of the importance of the customer or some problem or unusual deviation in the health score of the customer. The availability of a display such as that shown in FIG. 8 allows each sales person to keep a close watch on selected customers.

Because the method and system of the present invention allows both the customer and the software supplier to monitor the success level with which the customers are using the supplier's software, deficiencies in the success level can be monitored and improved. Accordingly, improvements can easily be made in the various success factors shown in the chart of FIG. 3. There may come a time when there has been such improvement that nearly all of the customers are achieving high scores in the tune up factor 50 (or another success factor). At that time, the tune up factor 50 no longer represents an accurate indicator of the success level of use of the software because it is being used successfully by all or nearly all of the customers.

The algorithmic process of the present invention contemplates dropping one or more of the success factors if a time should come when such factor or factors are being used successfully by nearly all of the customers. The factor that is dropped may be replaced by a new success factor. An example of a new factor that may be added to the algorithmic process in place of a factor that is dropped is a factor that measures how well the software is being integrated with various business systems the customer may use in its operations. In this way, the algorithmic process is maintained current as an accurate measure of the success level with which the customers are using the software.

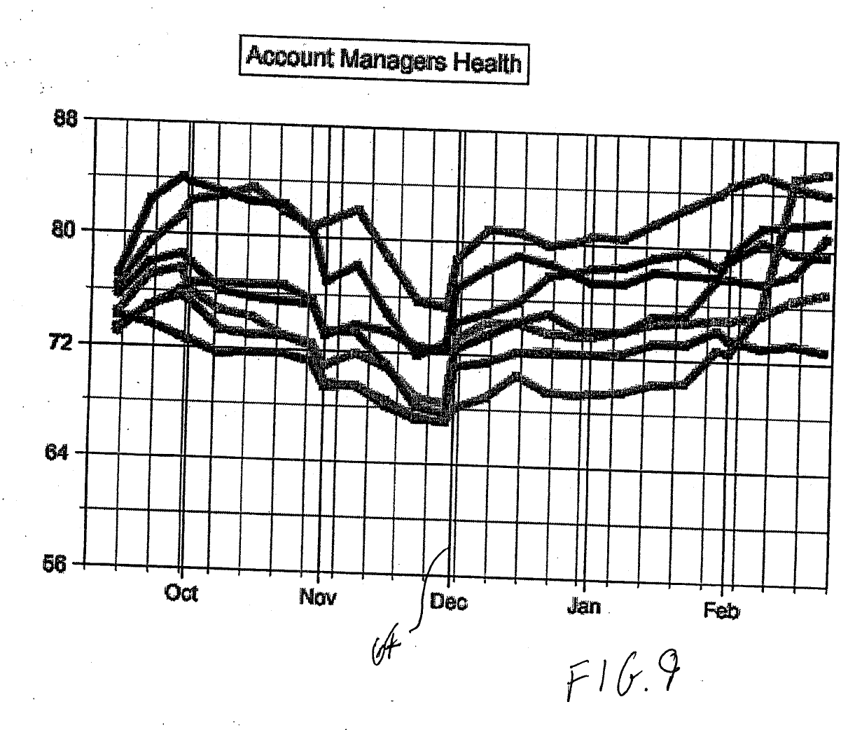

FIG. 9 is a chart that may be displayed on computer screens or otherwise to the sales personnel of the software supplier. The chart of FIG. 9 represents, in graph form, the overall average level of customer “health” (score) associated with a number of different sales personnel (seven account managers in the example of FIG. 9). This allows the trend of the customers of each account manager to be viewed in a graphic form and to be compared with the trends of other account managers. At the time indicated by the line identified by numeral 64 in FIG. 9, one of the success factors identified in FIG. 3 has been removed from the algorithmic process and replaced by a new factor. The success level for each manager changes at this time as is to be expected because the new factor is chosen such that the success level is lower than when the factor that is removed was taken into account.

The algorithmic process can be updated to current conditions at any desired interval. It is contemplated that it will be checked on a daily basis and adjusted to fit the current conditions so that current information will always be available, both to the appropriate personnel of the software supplier and to the customers.

In the event that the algorithmic process provides a score for a particular customer that is below a selected acceptable level, an alert can be immediately generated electronically or otherwise, both to the software supplier and to the customer. The alert indication that is provided preferably includes the score of the customer, along with an indication of the particular features or functions or other factor that has caused the score to drop below the acceptable level. Similarly, if there is a sudden deviation in the score of the particular customer that exceeds a predetermined amount indicative of a problem that should be addressed, an alert indication can be given to both the sales personnel of the software supplier and to the customer. Again, the alert indication preferably includes an indication of what feature or function or other factor has caused the sudden deviation in the score of the customer.

The alert indications that may be provided due to an unusually low score or an abrupt deviation in the score of any customer are preferably provided in a display that is available on the computer monitors of personnel in the sales organization of the software supplier. In particular, each account manager or sales manager assigned to a customer whose score has dropped to an unacceptable level or has been subject to a sudden deviation may be provided with a display that includes the alert indication, including an indication of what has caused the unduly low score or the sudden deviation in the score. The alert indications are preferably given periodically such as on a daily or weekly basis.

Thus, the method and system of the present invention provides for the monitoring of the success levels with which customers of application software are using the software. The success factors that are used in the algorithmic process of the invention are obtained by identifying features and factors that are used by users of the software that are know to be using it with a high level of success. These success factors thus provide an accurate measure of the success level at which the software can be used. By making use of these features and factors in an algorithmic process in order provide a scoring system such as exemplified by FIG. 3, the score obtained by each customer provides an accurate measure of how successfully the customer is making use of the software. Consequently, by applying the scoring system to all customers, each customer can be rated as to the success level with which it is using the software, and the success level can be monitored by both the customer and appropriate personnel in the sales organization of the software supplier. By using this information, the customer can improve its use of the software and the software supplier can intervene if necessary and attempt to improve the manner in which its customers are using the software, thereby enhancing the likelihood that the customers will renew their subscriptions to the software at the end of a subscription term.

Further, the various displays that can be provided are made available, preferably on computer screens that appropriate personnel can access with little difficulty. Each account manager or sales manager can easily call up on his or her computer screen a chart such as that shown in FIG. 4 for any customer assigned to the sales person. Overall displays such as that shown in FIG. 5 can be regularly provided to the entire sales force of the software supplier, such as on a monthly or other periodic basis. Ranking lists such as that shown in FIG. 6 can also be provided to the entire sales organization monthly or on some other periodic basis. Each sales manager or account manager can access on his or her computer screen a display such as that of FIG. 7 for the manager's entire roster of customers. A “watch list” such as shown on FIG. 8 can be displayed on the computer screen of each account manager or sales manager when desired or on a selected schedule. Graphic displays such as that of FIG. 9 can likewise be made available to personnel who can use the information it provides. Alert indications can be provided to the appropriate account managers or sales managers on a daily basis or another periodic basis if desired.

As previously indicated, success factors that are inapplicable to a particular customer can be removed from inclusion in the algorithmic process that is used to provide a success level score. Also, if one of the success factors or features is being used by customers at a collective success level that is above a selected level, thus indicating that such factor is no longer an accurate indication of the successful use of the software, that factor can be dropped out of the algorithmic process and replaced with a new factor which results in the creation of a new scoring system that is then applied to all of the customers in order to provide a new score for each of the customers. This maintains the accuracy of the scoring system and its validity as an indication of the level of success with which the software is being used.

The systems and methods described above can be implemented on hardware, firmware, and/or software for performing the operations described herein. Further, the methods described above may be stored on a machine readable (e.g. a computer-readable) media. Machine-readable media includes any mechanism that provides (e.g., stores and/or transmits) information in a form readable by a machine. For example, tangible machine-readable media includes read only memory (ROM), random access memory (RAM), magnetic disk storage media, optical storage media, flash memory machines, etc. In addition, the systems and methods described above may be implemented by using a processor. For example, a central processing unit, microprocessor, a network processor, a front end processor, a data processor or other appropriate processor may be used.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

1. A computer readable storage medium having stored thereon executable program code for monitoring the usage of multiple instances of application software by a combined plurality of users using the software at a variety of success levels, wherein the software has a variety of features that may be used, where when the program code is executed is operable to perform a method comprising the steps of:
(a) identifying features used by a combined plurality of users that use an instance of the software at a high level of success;
(b) using the features identified in step (a) to create a scoring system based on those features, wherein the scoring system provides a measure of the successful use of the instance of the software;
(c) applying the scoring system to all combined plurality of users on all instances of the software to provide a score for each combined plurality of users on the instance of the software; and
(d) monitoring the score of each combined plurality of users to monitor the level of success with which each combined plurality of users is using the software.

2. A computer readable storage medium as set forth in claim 1, further including the step of providing an alert indication when any of the score of the combined plurality of users has a score below a selected level.

3. A computer readable storage medium as set forth in claim 1, further including the step of alerting each user within the combined plurality of users whose score is below a selected score.

4. A computer readable storage medium as set forth in claim 3, where the step of alerting each user whose score is below a selected level includes informing each such user of a feature causing the score of each such user to be below the selected score.

5. A computer readable storage medium as set forth in claim 1, including the steps of:
determining when one of the features identified in step (a) is being used by the combined plurality of users at a collective success level above a selected level;
replacing steps (b), (c) and (d) with the steps of:
(e) creating a new scoring system based on the features identified in step (a) plus a new feature and without using said one feature;
applying the new scoring system to all combined plurality of users on all instances of the software to provide a new score for each combined plurality of users on each software instance; and
(g) monitoring the new score of each combined plurality of users to monitor the level of success with which each combined plurality users using each instance of the software.

6. A computer readable storage medium having stored thereon executable program code for monitoring the level of success with which application software licensed to a plurality of customers on a renewable subscription basis is being used by the plurality of customers, where when the program code is executed is operable to perform a method comprising the steps of:
(a) identifying successful customers within the plurality of customers that use the software at a high level of success;
(b) identifying factors related to usage of the software by the successful customers identified in step (a);
(c) using said factors to create a scoring system which takes said factors into account in a manner wherein the scoring system provides a measure of the level of success with which the software is used;
(d) applying the scoring system to the plurality of customers to provide a score for each customer within the plurality of customers that is a measure of the level of success with which each customer within the plurality of customers is using the software; and
(e) monitoring the score of each customer within the plurality of customers.

7. A computer readable storage medium as set forth in claim 6, further including the steps of:
(f) identifying any customer within the plurality of customers whose successful use of the software is not affected by at least one of said factors; and
(g) for any customer identified in step (f), carrying out step (c) with the exclusion of the at least one factor to create a scoring system.

8. A computer readable storage medium as set forth in claim 6, further including the step of providing the availability of a display containing the score of each customer within the plurality of customers.

9. A computer readable storage medium as set forth in claim 6, further including the step of providing the availability of a display containing a combined score of the plurality of the customers selected to be included in the display.

10. A computer readable storage medium as set forth in claim 6, wherein customers are arranged in a plurality of groups assigned to respective account supervisors, and further including the step of providing the availability of a display identifying the scores of all customers in the group assigned to each account supervisor.

11. A computer readable storage medium as set forth in claim 10, wherein said display contains at least one of said factors.

12. A computer readable storage medium as set forth in claim 6, further including the step of providing an alert indication when any one of the plurality of customers has a score below a pre-selected level.

13. A computer readable storage medium as set forth in claim 6, wherein a business organization includes a plurality of account supervisors each assigned to a different group of the customers, and further including the steps of:
providing a display containing an identification of all customers in each group and the scores of all customers in each group; and
making available to each account supervisor the display for the group assigned to such account supervisor.

14. A computer readable storage medium as set forth in claim 13, further including the steps of:
providing a second display including an identification of selected customers in each group and the scores of said selected customers; and
making available to each account supervisor the second display for the group assigned to such account supervisor.

15. A computer readable storage medium as set forth in claim 13, further including the steps of:
ranking the account supervisors comparatively based on the scores of the customers assigned to each account supervisor; and
providing a display of said ranking periodically to all of the account supervisors.

16. A method as set forth in claim 13, further including the steps of:
(f) periodically identifying each customer having a score below a selected level; and
(g) alerting each account supervisor assigned to a group having a customer identified in step (f).

17. A method as set forth in claim 13, further including the steps of:
(f) periodically identifying each customer having a score that deviates by a selected amount from a base level determined by one or more prior scores for such customer; and
(g) alerting each account supervisor assigned to a group having a customer identified in step (f).

18. A computer readable storage medium as set forth in claim 6, further including:
determining when one of the factors identified in step (b) is being used by the customers at a collective success level above a selected success level;
replacing steps (c), (d), and (e) with steps of;
(f) creating a new scoring system using the factors identified in step (b) plus a selected new factor and without using said one factor;
(g) applying said new scoring system to each customer to provide a new score for each customer that is a measure of the level of success with which each customer is using the software; and
(h) monitoring the new score of each customer.

19. A computer implemented system for determining the level of success with which application software is being used by a combined plurality of customers which includes select customers using the software at a high level of success, said system comprising:
a processor; and
a memory for storing means for identifying characteristics that are related to the use of the software by said select customers;
means for creating a scoring system that is based on said characteristics in a manner that the scoring system represents a measure of the level of success with which the software is used by the combined plurality of customers; and
means for applying said scoring system to each plurality of customers to provide for each plurality of customers a score representative of the level of success with which each combined plurality of customers is using the software.

20. A system as set forth in claim 19, further including means for providing an alert indication when the combined plurality of customers has a score below a selected level.

21. A system as set forth in claim 19, further including:
means for determining when one of the characteristics is indicative of the combined plurality of customers making use of the one characteristic at a selective high success level;
means for creating a new scoring system using the characteristics plus a selected new characteristic and without using the one characteristic wherein the new scoring system represents a measure of the level of success with which the software is being used by the combined plurality of customers; and
means for applying the new scoring system to each combined plurality of customers to provide for each combined plurality of customers a new score that is representative of the level of success with which each combined plurality of customers is using the software.

22. A system as set forth in claim 19, wherein the successful use of the software by at least one customer within the combined plurality of customers is substantially unaffected by at least one of the characteristics, and further including;
means for modifying said scoring system creating means for said at least one customer in a manner wherein said scoring system for said at least one customer is based on said characteristics excluding said at least one characteristic.

23. A system as set forth in claim 19, including means for displaying an identification of each customer within the combined plurality of customers and the score of each such customer.

24. A system as set forth in claim 23, further including means for making the identification of each customer and the score of each customer available to a selected audience.

25. A system as set forth in claim 19, further including means for displaying an identification of selected customers within the combined plurality of customers and the score for each of the selected customers.

26. A system as set forth in claim 19, further including:
means for identifying each customer within the combined plurality of customers having a score below a selected level; and
means for providing on a selected schedule an alert indication identifying to a selected audience each customer within the combined plurality of customers having a score below the selected level.

27. A system as set forth in claim 19, further including:
means for identifying each customer within the combined plurality of customers having a score that deviates by a selected amount from a base value based on prior scores of the combined plurality of customers; and
means for providing on a selected schedule an alert indication identifying to a selected audience each customer within the combined plurality of customers having a score that deviates by the selected amount from the base value.
